(19) United States
(12) Patent Application Publication
(10) Pub. No.: US 2026/0298407 A1
(43) Pub. Date: Oct. 1, 2026

(54) WORKSPACE PLATFORM ARM WITH CAMBER ADJUSTMENT

(71) Applicant: CKnapp Sales, Inc., Goodfield, IL (US)

(72) Inventors: Braden Martin, Eureka, IL (US); Micah Fehr, Danvers, IL (US)

(21) Appl. No.: 19/578,397

(22) Filed: Mar. 25, 2026

Related U.S. Application Data
(60) Provisional application No. 63/779,271, filed on Mar. 27, 2025.

(51) Int. Cl. F16M 13/02; F16M 11/10; F16M 11/20; F16M 11/28; F16M 11/42

(52) U.S. Cl. CPC F16M 13/022; F16M 11/10; F16M 11/2064; F16M 11/28; F16M 11/42; F16M 2200/022

(57) ABSTRACT

A worksurface platform assembly includes a worksurface platform, a mounting bracket or base, and a worksurface platform arm connected between the worksurface platform and the mounting bracket or base, the worksurface platform arm comprising a plurality of segments connected by one or more joints. The assembly further includes a camber adjustment comprising a pivot, a first member coupled to the worksurface platform, a second member coupled to a terminal segment of the worksurface platform arm, and a radially offset fastener extending through an oversize hole in one of the first member or the second member and fixed to the other of the first member or the second member. The pivot couples the first member to the second member for rotation about the pivot, and the radially offset fastener controls a rotational resistance of the first member relative to the second member about the pivot.

### CROSS-REFERENCE TO RELATED APPLICATIONS

This application claims the benefit of U.S. Provisional Application No. 63/779,271, filed Mar. 27, 2025. The entire disclosure of the above-identified application is incorporated herein by reference.

### FIELD OF THE INVENTION

The present disclosure relates to worksurface platform assemblies including a worksurface platform adjustably mounted to an arm

### BACKGROUND

Different types of worksurface platforms include desks, laptop trays, keyboard trays, bedside tables and others. Such worksurface platforms may be mounted on a multiple segment arm to provide adjustable positioning.

### BRIEF SUMMARY

The present disclosure relates to worksurface platform assemblies including a camber adjustment for leveling a worksurface platform side to side relative to a worksurface platform arm and a mounting bracket or base. Worksurface platform arms disclosed herein include multiple segments and joints to facilitate adjustable positioning. The worksurface platform arms disclosed herein further include a camber pivot with a limited range to facilitate leveling the worksurface platform side to side. The limited range may be useful to account for stacked tolerances of the multiple segments and joints in the worksurface platform arms.

According to one aspect of the present disclosure, a worksurface platform assembly includes a worksurface platform, a mounting bracket or base, and a worksurface platform arm connected between the worksurface platform and the mounting bracket or base, the worksurface platform arm comprising a plurality of segments connected by one or more joints. The assembly further includes a camber adjustment comprising a pivot, a first member coupled to the worksurface platform, a second member coupled to a terminal segment of the worksurface platform arm, and a radially offset fastener extending through an oversize hole in one of the first member or the second member and fixed to the other of the first member or the second member, wherein the pivot couples the first member to the second member for rotation about the pivot, and the radially offset fastener controls a rotational resistance of the first member relative to the second member about the pivot.

According to another aspect of the present disclosure, a worksurface platform assembly includes a worksurface platform, a mounting bracket or base, and a worksurface platform arm connected between the worksurface platform and the mounting bracket or base, the worksurface platform arm comprising a plurality of segments connected by one or more joints. The assembly further includes a camber adjustment comprising a pivot, a first member coupled to the worksurface platform, a second member coupled to a terminal segment of the worksurface platform arm, and a radially offset fastener extending through an arcuate slot in one of the first member or the second member and fixed to the other of the first member or the second member, wherein the pivot couples the first member to the second member for rotation about the pivot, and wherein the radially offset fastener extending through the arcuate slot simultaneously limits a range of angular rotation of the first member relative to the second member by abutting an end of the arcuate slot at a limit of angular travel, and controls a rotational resistance of the first member relative to the second member by a clamping force between the first member and the second member.

According to another aspect of the present disclosure, a worksurface platform assembly includes a worksurface platform, a mounting bracket or base, and a worksurface platform arm connected between the worksurface platform and the mounting bracket or base, the worksurface platform arm comprising a plurality of segments connected by one or more joints. The assembly further includes a camber adjustment comprising a pivot, a first member coupled to the worksurface platform, a second member coupled to a terminal segment of the worksurface platform arm, and a pin extending through an oversize hole in one of the first member or the second member, wherein the pivot couples the first member to the second member for rotation about the pivot and controls a rotational resistance of the first member relative to the second member about the pivot, and wherein the pin limits a range of angular rotation of the first member relative to the second member.

The foregoing summary is illustrative only and is not intended to be limiting. Additional aspects, features, and advantages of the present disclosure will be apparent from the detailed description and figures set forth below.

### BRIEF DESCRIPTION OF THE DRAWINGS

FIGS. 1A and 1B illustrate a pneumatic wall-mounted keyboard tray assembly 100 in perspective view and a detail of camber adjustment 150, respectively, according to one example.

FIG. 2 illustrates a pneumatic wall-mounted laptop tray assembly 200 in perspective view, according to one example.

FIG. 3 illustrates a clamp-mount worksurface platform assembly 300 in perspective view, according to one example.

FIGS. 4A, 4B, and 4C illustrate a telescoping arm assembly 400 in perspective view, and details of camber adjustment 450 in perspective and front views, respectively, according to one example.

FIG. 5 illustrates a laptop cart with extension arm assembly 500 in perspective view, according to one example.

FIG. 6 illustrates a swivel couch desk assembly 600 in perspective view, according to one example.

FIG. 7 illustrates an under-mattress desk assembly 700 in perspective view, according to one example.

### DETAILED DESCRIPTION

The following description sets forth illustrative examples of the present disclosure. Such description is not intended as a limitation on the scope of the disclosure, which encompasses the described examples, modifications thereof, and combinations of features described herein.

Worksurface platform arms disclosed herein include multiple segments to facilitate adjustable positioning. Such arms may provide adjustable positioning in up to three dimensions (up, down, side-to-side, forwards and backwards) relative to a base or mounting point. In addition, such arms may facilitate tilt positioning, to allow the platform to be tilted to a position preferred by a user (such as with a keyboard tray) and/or to facilitate tilting the worksurface platform in an up or down position to reduce its footprint while not being used.

The worksurface platform arms may include several segments and joints to facilitate the adjustable positioning of the worksurface platform. Such segments may include telescoping segments, hinge joints, four-bar linkages and others. Motion may be restricted with friction joints, lockable gas springs, and/or clamping joints.

The worksurface platform arms disclosed herein further include a camber pivot with a limited range to facilitate leveling the worksurface platform side to side. The limited range may be useful to account for stacked tolerances of the multiple segments and joints in the worksurface platform arms. As used herein, “camber adjustment” refers to a side-to-side or lateral level adjustment of the worksurface platform.

In some worksurface platform arms comprising a plurality of segments interconnected by one or more joints, angular tolerances at each joint may compound across the segments, producing a cumulative lateral tilt at the distal end of the arm that increases with the number of segments and joints in the arm. The camber adjustment may correct this compound angular accumulation by providing a limited-range rotational adjustment at or near the distal end of the arm, allowing the user to level the worksurface platform side to side independently of the angular contributions of the individual segments and joints

In particular examples, the camber pivot includes a camber pivot for a mounting bracket of the worksurface platform. The limited range is provided by a screw or bolt extending through an oversized hole at a radial position relative to the camber pivot. The screw or bolt may be adjusted to control the rotational resistance at the camber adjustment.

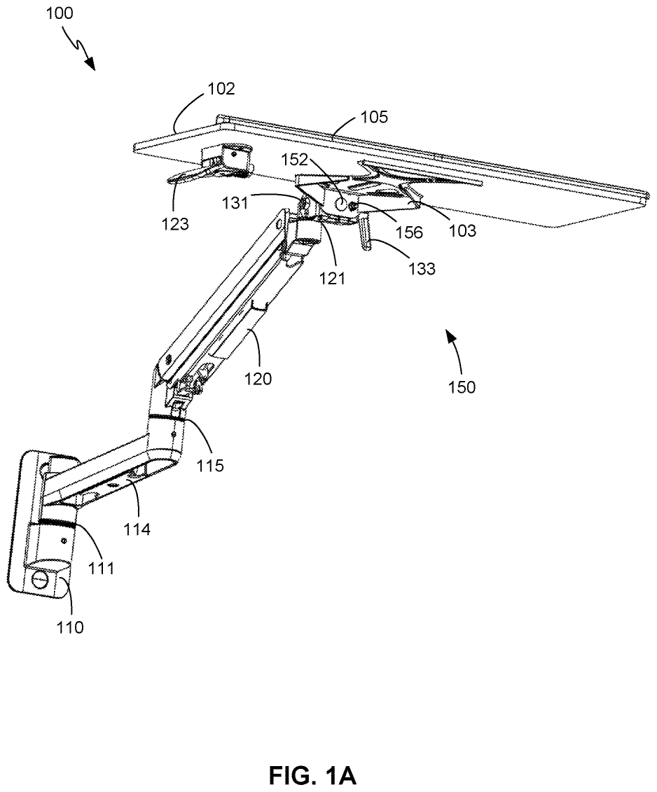

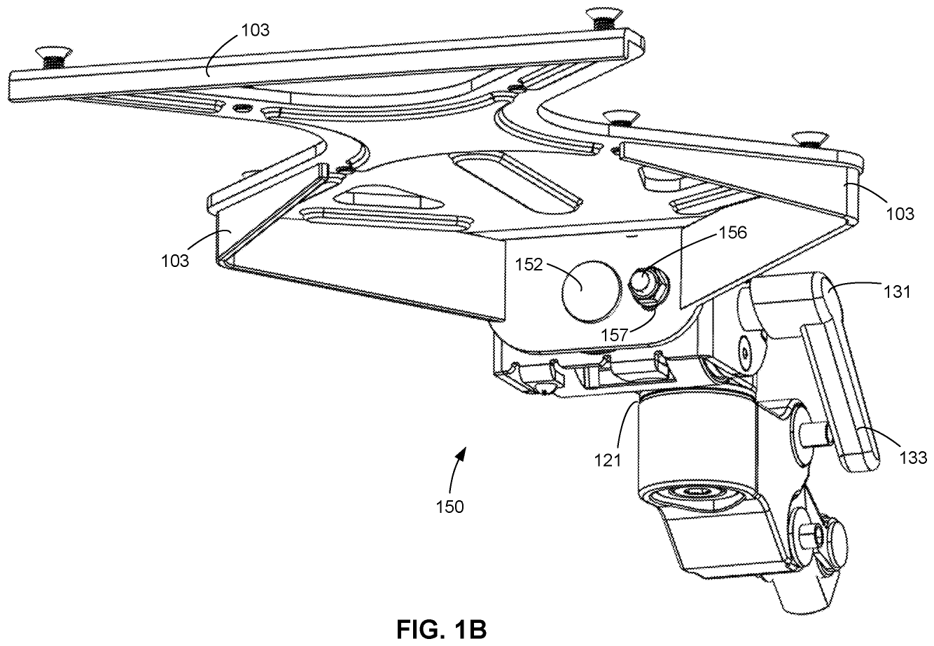

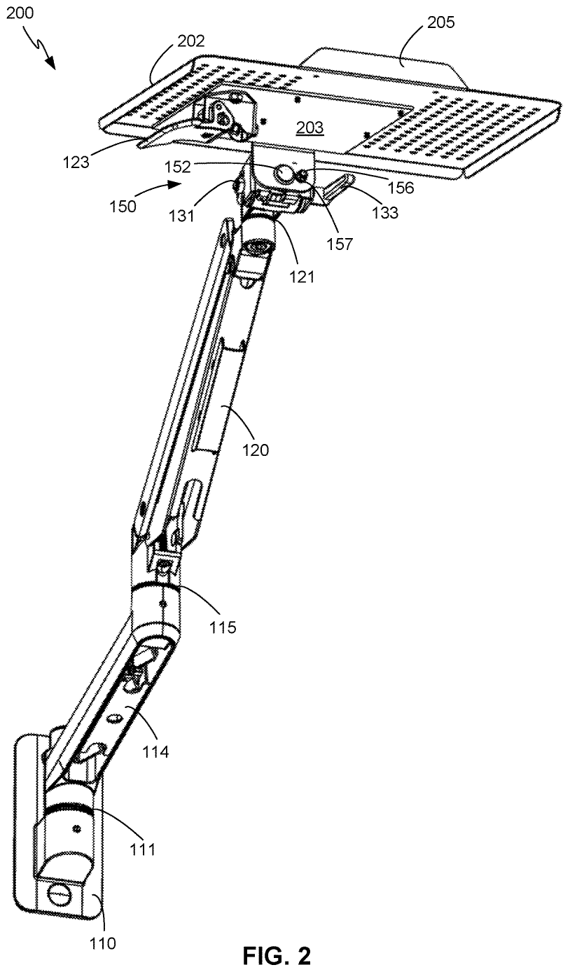

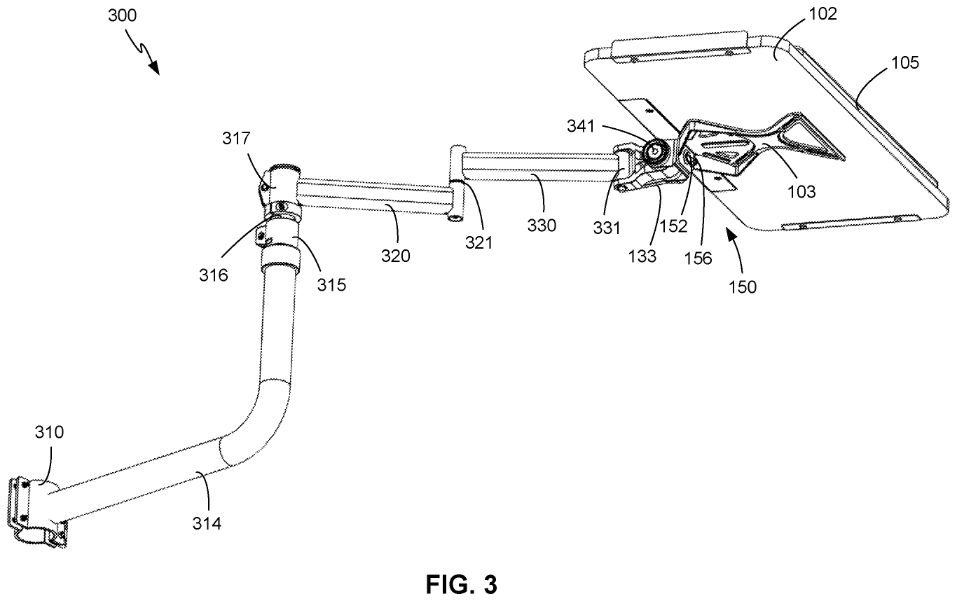

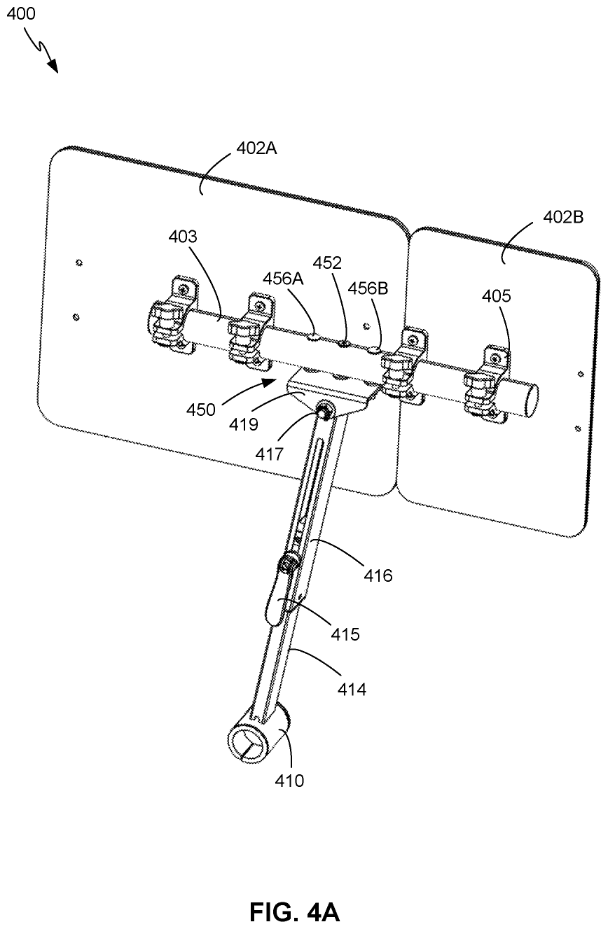

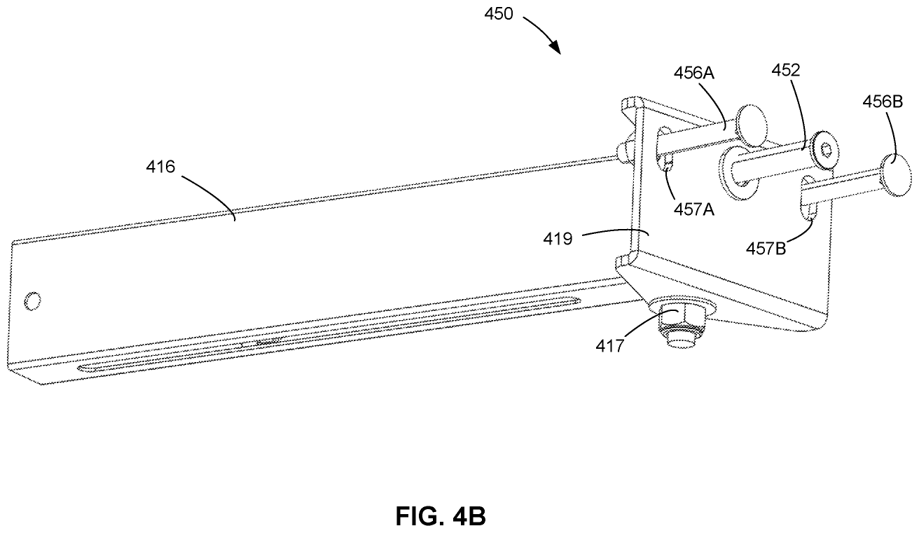

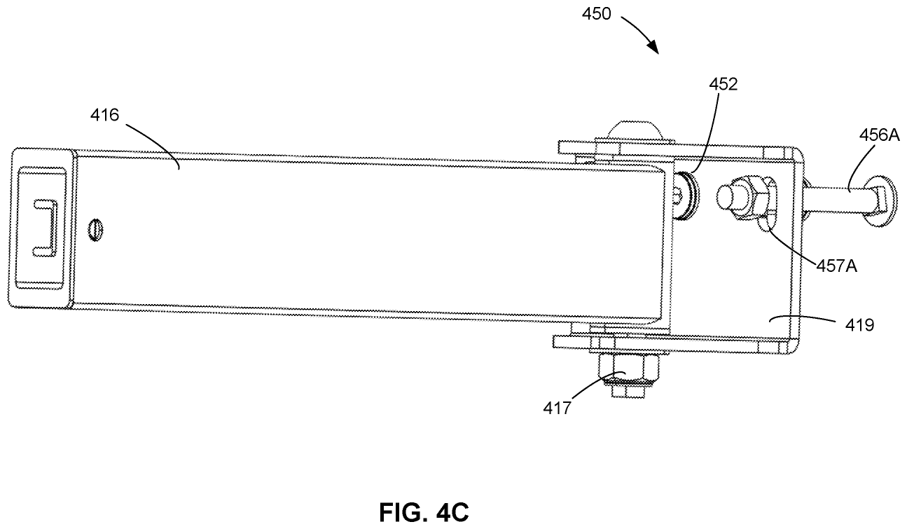

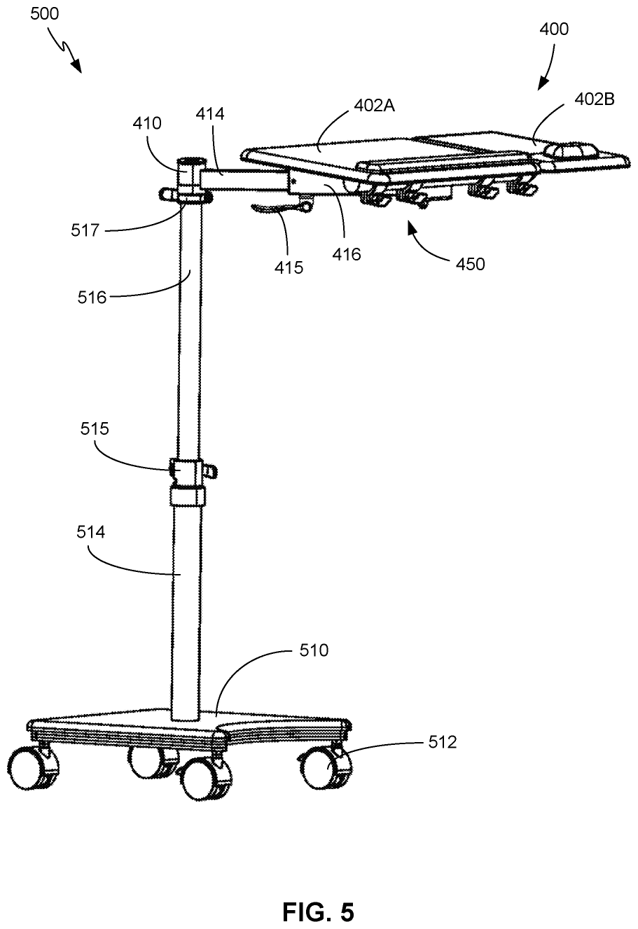

FIGS. 1A, 1B, and 2 illustrate wall-mounted worksurface platform assemblies with pneumatic four-bar linkage arms and single-fastener camber adjustments; FIG. 3 illustrates a clamp-mounted variant of the same general arm and camber configuration; FIGS. 4A, 4B, and 4C illustrate a telescoping arm assembly with a dual-pin camber adjustment, which serves as the arm subassembly for the cart, floor stand, and under-mattress desk assemblies of FIGS. 5, 6, and 7. Features of any example may be combined with features of any other example.

FIGS. 1A and 1B illustrate a worksurface platform assembly 100 according to one example. Assembly 100 is a wall-mounted keyboard tray assembly that supports a worksurface platform 102, in this example, a keyboard tray, at an adjustable height and tilt angle relative to a mounting bracket 110 secured to a wall or other vertical support surface. A camber adjustment 150 allows side-to-side leveling of the worksurface platform 102 independently of height and tilt adjustments.

Mounting bracket 110 attaches to the wall surface and serves as the fixed base of assembly 100. A joint 111 connects mounting bracket 110 to a first segment 114 of the worksurface platform arm. Segment 114 is a solid, elongated structural member that extends outward from joint 111. A second joint 115 connects segment 114 to a second segment 120.

Segment 120 is a four-bar linkage incorporating a locking gas spring, which allows the outer end of segment 120 to travel through an arc while maintaining a substantially fixed angular relationship between the inner and outer link members of the four-bar geometry. A lever 123 attached to segment 120 releases the locking gas spring to allow height adjustment of the arm; releasing lever 123 locks the gas spring and fixes the arm at the selected height. A third joint 121 connects the outer end of segment 120 to a tilt joint 131.

Tilt joint 131 allows the worksurface platform 102 to pivot forward and rearward, toward and away from the user, to a selected tilt angle. A tilt lever 133 adjusts and fixes the forward/rearward tilt angle at tilt joint 131. Camber adjustment 150 is interposed between tilt joint 131 and a worksurface platform mount 103. Worksurface platform mount 103 carries the worksurface platform 102 and a wrist pad 105 positioned along the front edge of the worksurface platform.

Camber adjustment 150 provides side-to-side leveling of the worksurface platform 102 and comprises a pivot 152, a radially offset fastener 156, and, as shown in FIG. 1B, an oversize hole 157 through which fastener 156 passes. Pivot 152 defines a rotation axis about which a first member rotates relative to a second member when the camber adjustment is operated. In the example of assembly 100, the first member is worksurface platform mount 103 and the second member is the structure at joint 121 that couples to tilt joint 131. Fastener 156 is positioned at a radial distance from pivot 152, and oversize hole 157 is dimensioned to be larger in at least one direction than the shank of fastener 156, providing clearance for rotation of the first member relative to the second member about pivot 152. To level the worksurface platform 102 side to side, the user adjusts the camber position by one of two modes: applying manual force directly to the worksurface platform 102 or worksurface platform mount 103 to overcome the rotational resistance set by fastener 156, or loosening fastener 156, rotating worksurface platform mount 103 about pivot 152 until the platform is level, and retightening fastener 156 to fix the adjusted camber position.

The angular range of adjustment is determined by the clearance geometry of oversize hole 157 relative to fastener 156. In some examples, the angular range of adjustment is within approximately +/−10 degrees, within approximately +/−5 degrees, within approximately +/−3 degrees, or within approximately +/−1 degree, depending on the clearance provided by oversize hole 157. The camber adjustment of assembly 100 is described in further detail with respect to FIG. 1B.

In some examples, the locking gas spring of segment 120 is replaced by a friction-damped pivot or a ratchet mechanism that resists motion under load and releases upon manual actuation, providing height adjustment by a different means than pneumatic assistance. A cable routing channel may be integrated into one or more segments of the arm, for example, along the interior of segment 114 or segment 120, to conceal cables connecting peripherals on the worksurface platform to equipment at the mounting location. The cable routing channel may be a slot, groove, or enclosed conduit formed in or attached to the segment.

In other examples, tilt joint 131 is a friction-disc joint in which the forward/rearward tilt angle is set by torque applied directly to a clamping bolt at the joint rather than through a dedicated tilt lever. Tightening the clamping bolt increases the normal force between friction surfaces at tilt joint 131, fixing the tilt angle; loosening the bolt reduces friction and permits manual repositioning of the platform. This configuration eliminates tilt lever 133 and its associated hardware, yielding a lower-profile joint interface. In still other examples, tilt adjustment is provided by a detented friction joint that provides discrete, tactile tilt positions without a separate lever or bolt adjustment.

Wrist pad 105, in some examples, is a removable and reversible attachment rather than a fixed component of worksurface platform 102. In such examples, wrist pad 105 is retained along the front edge of worksurface platform 102 by clips, a hook-and-loop interface, or a slot-and-tab engagement that allows the wrist pad to be detached for cleaning, replacement, or reconfiguration without tools. A reversible attachment also allows the wrist pad to be repositioned or omitted entirely for use cases where a flush platform surface is preferred.

Platform mount 103, in some examples, is configured as a universal VESA-compatible interface that accepts standardized mounting hardware from third-party worksurface platforms or display trays. In such a configuration, the output face of camber adjustment 150 presents a VESA-pattern hole array, for example, a 75 mm×75 mm or 100 mm×100 mm pattern, allowing any platform with a compatible VESA receiver to attach directly to the camber adjustment output. This interface decouples the worksurface platform selection from the arm configuration and supports future attachment of a broad range of platform types without modification to the camber adjustment or arm.

Segment 114, in some examples, is a telescoping solid segment incorporating a collar lock that allows the length of segment 114 to be adjusted rather than fixed. In this configuration, an inner tube slides within an outer tube forming segment 114, and a collar lock, operated by a clamp lever or threaded collar, fixes the selected extension length. This alternative accommodates installations where the fixed reach of a non-telescoping segment 114 is insufficient or where variable reach is desired without replacing the pneumatic height adjustment provided by segment 120. The telescoping solid segment alternative described in this section is applicable across the wall-mounted arm configurations described herein and is not repeated in subsequent figure sections.

Structural components of assembly 100, including segments 114 and 120, mounting bracket 110, joints 111, 115, and 121, tilt joint 131, and worksurface platform mount 103, are formed from metal, such as aluminum or steel, or from engineering plastics such as glass-filled nylon, or combinations thereof. Worksurface platform 102 is formed from plastic, wood composite, metal, or combinations thereof. In some examples, the worksurface platform assembly supports loads of approximately 2 kg to 100 kg or more. Fastener 156 is, in some examples, an M5 to M8 screw or bolt. Where assembly 100 is wall-mounted into wood studs, the mounting bracket 110 is secured in one example using ST6.3×55 mm screws with M6 washers, with a pilot hole of approximately 3/16 in. (approximately 4.5 mm) drilled to a depth of approximately 2.2 in. (55 mm). Where mounting into concrete or masonry, concrete anchors are used in another example with ST6.3×55 mm screws, with a pilot hole of approximately ⅜ in. (approximately 10 mm) drilled to a depth of approximately 2.4 in. (60 mm).

FIG. 1B illustrates a detail view of camber adjustment 150 of assembly 100. The view shows worksurface platform mount 103, joint 121, tilt joint 131, tilt lever 133, pivot 152, radially offset fastener 156, and oversize hole 157.

Pivot 152 is a structural connection, for example, a pin, bolt, or formed boss, about which worksurface platform mount 103 rotates relative to the adjacent structure at joint 121 when the camber position is adjusted. Pivot 152 establishes the axis of rotation of the camber adjustment and is the fixed reference point about which side-to-side leveling rotation occurs. Radially offset fastener 156 passes through oversize hole 157 in one of the first and second members and threads into or bears against the other. Oversize hole 157 is larger than the shank diameter of fastener 156 in at least the circumferential direction relative to pivot 152, creating an arcuate clearance zone that permits angular rotation of the first member relative to the second member without requiring removal or repositioning of fastener 156. Fastener 156 controls a rotational resistance of the first member relative to the second member about pivot 152. When fastener 156 is tightened, the head or bearing surface of fastener 156 increases a clamping force between the first and second members, increasing the rotational resistance at the camber adjustment. The degree of rotational resistance is selectively adjustable by the user by tightening or loosening fastener 156.

In a first mode of operation, fastener 156 is tightened to a friction-control setting at which the clamping force between the first and second members produces a rotational resistance that permits the user to adjust the camber position by applying manual force directly to the worksurface platform or worksurface platform mount 103 without loosening fastener 156. In this mode, the camber adjustment functions as a friction joint: the first member rotates relative to the second member about pivot 152 when the user-applied force exceeds the rotational resistance set by fastener 156, and the first member remains at the adjusted camber position when the user-applied force is removed because the rotational resistance exceeds the gravitational and inertial loads acting on the worksurface platform. The user tightens fastener 156 to increase the rotational resistance when the joint becomes too loose over the service life of the assembly, restoring sufficient stiffness to maintain the camber position under load.

In a second mode of operation, fastener 156 is tightened to a position-lock setting at which the clamping force between the first and second members fixes the angular position of the first member relative to the second member about pivot 152, resisting rotation under all expected service loads. In the second mode, the user loosens fastener 156, rotates worksurface platform mount 103 about pivot 152 to the desired camber position, and retightens fastener 156 to fix the adjusted position. In some examples, a friction washer is interposed between the bearing surface of fastener 156 and the surface of the member through which fastener 156 passes, increasing the clamping force at a given fastener torque and resisting loosening of fastener 156 under vibration or repeated loading. The friction washer is, in some examples, a split lock washer, a serrated flange washer, or a Belleville washer.

The single radially offset fastener 156 and oversize hole 157 configuration of assembly 100 represents one approach to the clamping function of the camber adjustment. In other examples, the pivot itself serves as both the rotation axis and the clamping element, for example, a pivot bolt tightened directly through a concentric oversize aperture in the first member, eliminating a separate radially offset fastener. In such a configuration, tightening the pivot bolt draws the first and second members into frictional engagement at the pivot interface, fixing the camber position without a secondary fastener. In yet other examples, the camber adjustment includes a second radially offset fastener at a different angular position relative to pivot 152, forming a three-point constraint, pivot plus two fasteners, that distributes clamping load across a larger arc and increases resistance to rotation under eccentric loading. Each of the two fasteners in such an arrangement passes through a respective oversize hole sized to permit the same angular range of adjustment as in the single-fastener configuration.

The geometry of oversize hole 157 governs the angular range of the camber adjustment. In examples where the radially offset fastener extends through the oversize hole, the fastener limits the range of angular rotation of the first member relative to the second member by abutting edges of the oversize hole at the limits of the range. In examples where the oversize hole comprises an arcuate slot, the fastener abuts an end of the arcuate slot at a limit of angular travel. In some examples, oversize hole 157 is circular or oblong and sized to provide the desired angular clearance for fastener 156 over the intended adjustment range. In assembly 100, the oversize hole is non-circular, for example, an arcuate slot centered on pivot 152, which constrains radial movement of fastener 156 while permitting circumferential travel through the arc of adjustment. An arcuate slot configuration concentrates clamping force along the arc path and can reduce stress concentration at the hole periphery compared to a circular oversize hole. In still other examples, the periphery of oversize hole 157 incorporates spring-loaded detents at discrete angular positions, providing indexed camber settings that resist rotation to intermediate positions while allowing the user to select among a defined set of pre-calibrated camber angles.

In examples where the oversize hole comprises an arcuate slot, the radially offset fastener extending through the arcuate slot simultaneously performs two functions: the fastener limits the range of angular rotation of the first member relative to the second member by abutting an end of the arcuate slot at a limit of angular travel, and the fastener controls the rotational resistance of the first member relative to the second member by the clamping force between the first and second members as described with respect to the first and second modes of operation. The range-limiting function and the friction-control function are provided concurrently by the same fastener in the same arcuate slot, without requiring separate structural elements for each function.

The detents engage the shank of fastener 156 as it passes through the oversize hole, providing tactile feedback at each indexed position. Regardless of hole geometry, the oversize hole is sized to provide an angular range of adjustment of within approximately +/−10 degrees, within approximately +/−5 degrees, within approximately +/−3 degrees, or within approximately +/−1 degree about pivot 152, with the specific range selected based on the installation requirements and the degree of levelness correction needed.

The alternatives described in this section with respect to the pivot-bolt configuration, three-point fastener arrangement, non-circular oversize hole geometry, and indexed detent positions are applicable across the camber adjustment configurations described herein and are not repeated in subsequent figure sections. The second member of the camber adjustment is coupled to the terminal segment of the worksurface platform arm, that is, the segment at the distal end of the arm from which the camber adjustment and worksurface platform depend.

FIG. 2 illustrates a worksurface platform assembly 200 according to one example. Assembly 200 is a wall-mounted laptop tray assembly that shares the arm architecture and camber adjustment of assembly 100 but substitutes a laptop tray platform for the keyboard tray platform.

Mounting bracket 110, joints 111, 115, and 121, segments 114 and 120, lever 123, tilt joint 131, tilt lever 133, and camber adjustment 150 of assembly 200 are structurally identical to the corresponding elements of assembly 100 and operate in the same manner. The description of those elements set forth with respect to FIGS. 1A and 1B applies equally to assembly 200 and is not repeated here.

Assembly 200 differs from assembly 100 in the worksurface platform and platform mount. Worksurface platform mount 203 couples to the first member of camber adjustment 150 and carries a worksurface platform 202 configured as a laptop tray. Worksurface platform 202 includes a retaining lip 205 along at least one edge, in this example, the front edge, that projects upward from the platform surface to retain a laptop or other device against sliding off the tray under forward tilt or during repositioning of the arm. Retaining lip 205 is a raised structural feature formed integrally with or attached to worksurface platform 202. The platform surface of worksurface platform 202 is dimensioned to accommodate a range of laptop sizes and provides a substantially flat support surface between retaining lip 205 and the rear edge of the tray.

The side-to-side leveling operation of camber adjustment 150 in assembly 200 is identical to that described with respect to assembly 100: the user adjusts the camber position by applying manual force to the worksurface platform 202 or platform mount 203 to overcome the rotational resistance set by fastener 156, or by loosening fastener 156, rotating platform mount 203 about pivot 152 to the desired camber position, and retightening fastener 156 to fix the adjusted position.

FIG. 3 illustrates a worksurface platform assembly 300 according to one example. Assembly 300 is a clamp-mounted worksurface platform assembly that attaches to a desk edge, shelf, or similar surface rather than to a wall, and carries a keyboard tray platform via an arm constructed from a different segment and joint configuration than the pneumatic assemblies of FIGS. 1A and 2.

Assembly 300 includes a clamp mount 310 that attaches to a horizontal or vertical surface edge via a clamping mechanism. A bent post 314 extends from clamp mount 310 and positions the arm assembly at a selected lateral and vertical offset from the clamped surface. A height adjustment collar 315 on bent post 314 allows coarse height positioning of the arm relative to the post. A segment 316 extends from height adjustment collar 315, and a post clamp mount 317 connects segment 316 to the arm structure.

A first bar 320 and a second bar 330 extend from post clamp mount 317, coupled to the remaining arm structure by hinges 321 and 331, respectively. Bars 320 and 330 in combination with their respective hinges form a parallel linkage that guides the worksurface platform through an arc during height adjustment while maintaining a substantially constant platform orientation. A tilt adjustment 341 at the distal end of the arm allows forward/rearward tilt of the worksurface platform and serves the same function as tilt joint 131 in assembly 100. In assembly 300, a separate tilt lever is not shown; tilt adjustment 341 incorporates a friction or locking mechanism adjustable at the joint itself.

Worksurface platform mount 103, worksurface platform 102, wrist pad 105, camber adjustment 150, and pivot 152 of assembly 300 correspond to the identically numbered elements of assembly 100 and operate in the same manner. Radially offset fastener 156 and the camber adjustment operation are as described with respect to FIGS. 1A and 1B. Assembly 300 thus provides the same side-to-side leveling capability as assembly 100 through the same single-fastener camber adjustment mechanism, applied to an arm mounted via a desk clamp rather than a wall bracket.

In some examples, the mounting base of assembly 300 incorporates a wall-stud anchor bracket as an alternative to clamp mount 310, allowing assembly 300 to be secured directly to wall framing through a surface such as drywall using structural anchor hardware. This configuration provides a fixed-position desk-surface mounting alternative for installations where a wall anchor is preferred over a clamp.

In other examples, clamp mount 310 is configured for through-desk grommet installation: a bolt or threaded shaft passes through a grommet hole in the desk surface and is secured from below with a washer and nut, distributing the clamping load across the desk surface rather than bearing against the desk edge. This configuration is suited to surfaces where edge clamping is not practical, for example, surfaces without accessible edges, surfaces with finished edge trim, or desks with integrated cable management cutouts that provide a convenient grommet aperture.

In still other examples, bent post 314 is replaced by a straight post paired with an offset adapter bracket that repositions the arm assembly at the same lateral and vertical offset achieved by the bent geometry. The straight post and offset adapter bracket configuration accommodates the same arm assembly through a different post geometry, allowing the post to be manufactured as a simpler straight extrusion while the offset function is carried by the adapter bracket. This alternative also permits the same straight post to be used with different adapter brackets presenting different offsets, providing configurability without replacing the post itself.

FIGS. 4A, 4B, and 4C illustrate a worksurface platform assembly 400 according to one example. Assembly 400 is a telescoping extension arm assembly that attaches to a pole or post via a post clamp mount and supports a split two-part worksurface platform via a dual-pin camber adjustment. Assembly 400 serves as the arm subassembly for the rolling cart, floor stand, and under-mattress desk assemblies of FIGS. 5, 6, and 7.

Post clamp mount 410 attaches to a pole or post and serves as the fixed base of assembly 400 in the same functional role that mounting bracket 110 serves in assembly 100. A first telescoping segment 414 extends from post clamp mount 410. A cam lock lever 415 at the telescoping joint between segment 414 and a second telescoping segment 416 allows height adjustment of the arm: operating cam lock lever 415 releases the telescoping relationship between segments 414 and 416, permitting the user to extend or retract segment 416 relative to segment 414 to select the working height; releasing cam lock lever 415 locks the telescoping joint and fixes segments 414 and 416 at the selected extension.

A hinge 417 at the distal end of telescoping segment 416 connects the arm to a pivot bracket 419. Pivot bracket 419 is a structural bracket that carries the first member of camber adjustment 450 and positions the camber adjustment between the arm and the worksurface platform.

Camber adjustment 450 is the dual-pin counterpart to the single-fastener camber adjustment 150 of assembly 100. As used herein, “pin” refers to any elongated element which could extend through an oversize hole, including a screw, bolt, rivet, dowel pin, cotter pin, clevis pin, shoulder bolt, fixed post or tab. Camber adjustment 450 comprises a pivot 452, a first member, a second member, a first radially offset pin 456A extending through a first oversize hole 457A, and a second radially offset pin 456B extending through a second oversize hole 457B. As shown in FIG. 4B, pivot bracket 419 constitutes the first member and the structure at hinge 417 and telescoping segment 416 constitutes the second member. Pin 456B and oversize hole 457B are not shown in FIG. 4C for clarity of illustration of the camber adjustment components; pin 456A and oversize hole 457A are representative of both pin and hole pairs in that view. Pivot 452 couples the first and second members and defines the rotation axis of the camber adjustment.

Radially offset pins 456A and 456B are each positioned at a radial distance from pivot 452 at different angular positions, and oversize holes 457A and 457B each provide arcuate clearance for their respective pins over the angular range of adjustment. Pins 456A and 456B limit the range of angular rotation of the first member relative to the second member by abutting the ends of their respective oversize holes at the limits of angular travel. Pivot 452 controls the rotational resistance of the first member relative to the second member. Pivot 452 is, in some examples, a bolt, a shoulder bolt, or a threaded boss that, when tightened, increases a clamping force between the first and second members, increasing the rotational resistance at the camber adjustment. The degree of rotational resistance is selectively adjustable by tightening or loosening pivot 452.

In a first mode of operation, pivot 452 is tightened to a friction-control setting at which the clamping force between the first and second members produces a rotational resistance that permits the user to adjust the camber position by applying manual force directly to the worksurface platform without loosening pivot 452. In a second mode of operation, pivot 452 is tightened to a position-lock setting at which the clamping force fixes the angular position of the first member relative to the second member, resisting rotation under all expected service loads. In the second mode, the user loosens pivot 452, rotates pivot bracket 419 about pivot 452 until the platform is level, and retightens pivot 452 to fix the adjusted position.

In some examples, a friction washer is interposed between the first and second members at pivot 452, increasing the clamping force at a given torque and resisting loosening under vibration or repeated loading. The friction washer is, in some examples, a split lock washer, a serrated flange washer, or a Belleville washer. The dual-pin configuration distributes the range-limiting function across two locations, increasing resistance to over-rotation under the eccentric loading conditions that arise when a laptop or other device is positioned asymmetrically on the platform.

Bar 403 connects to pivot bracket 419 and carries the worksurface platform. The worksurface platform of assembly 400 comprises a first part 402A and a second part 402B, a split two-part configuration in which the two platform parts are each mounted to bar 403 via clamp brackets 405. The split configuration allows independent lateral positioning of each platform part along bar 403, accommodating a range of device footprints and keyboard-plus-peripheral arrangements on the same arm.

In some examples, the telescoping joint between segments 414 and 416 is actuated by a hydraulic or pneumatic mechanism in place of cam lock lever 415, providing powered height adjustment of the arm. In other examples, pivot bracket 419 is formed as an integral extrusion of the terminal end of telescoping segment 416 rather than as a separate attached bracket, yielding a unitary arm-to-camber interface that reduces part count and potential misalignment at the joint. A camber adjustment incorporating three or more radially offset pins, each passing through a respective oversize hole at a distinct angular position relative to pivot 452, may also be used in place of the dual-pin configuration of assembly 400, further distributing clamping load and providing additional resistance to rotation for heavier platform configurations.

Bar 403, in some examples, is a width-adjustable telescoping or sliding rail rather than a fixed-length member. In this configuration, bar 403 comprises inner and outer rail sections that slide relative to each other, and each of platform parts 402A and 402B is positioned along the rail and fixed via a slot-and-bolt engagement that permits stepless lateral positioning across the rail length. This configuration accommodates a wider range of device footprints and platform configurations without replacing bar 403.

For installations where stepless lateral positioning of the platform parts is desired without discrete clamp brackets, bar 403 may incorporate a continuous friction-fit groove or channel along its length rather than discrete mounting points. In this configuration, platform parts 402A and 402B seat into the groove and are retained by friction when positioned correctly; a locking mechanism along the groove, for example, a captive set screw engaging the groove wall, fixes the selected lateral position without requiring separate clamp brackets 405. This design eliminates the discrete clamping points of the clamp bracket configuration and allows the platform parts to be slid and repositioned without removing fasteners.

Cam lock lever 415, in some examples, is replaced by a quick-release pull-pin with spring-loaded re-engagement. In this configuration, a pin retained in a bore through segments 414 and 416 is pulled outward against a spring to release the telescoping joint; releasing the pin allows the spring to re-engage the pin into the corresponding bore in the mating segment, locking the selected extension without requiring a rotational cam operation. Pull-pin configurations are suited to applications requiring single-handed height adjustment, as the pin can be pulled and held while the segment is repositioned, then released to lock.

Structural components of assembly 400, including telescoping segments 414 and 416, post clamp mount 410, hinge 417, and pivot bracket 419, are formed from metal, such as aluminum or steel, or from engineering plastics such as glass-filled nylon, or combinations thereof, as described with respect to assembly 100. Shared material and dimensional details from the description of assembly 100 apply equally to assembly 400 and are not repeated here.

FIG. 5 illustrates a worksurface platform assembly 500 according to one example. Assembly 500 is a rolling cart worksurface platform assembly in which the arm and camber adjustment unit of assembly 400 is mounted to a freestanding rolling cart base, providing a mobile workstation configuration.

Assembly 500 includes a rolling cart base 510 supported on a plurality of casters 512 that allow the assembly to be repositioned across a floor surface. A pole 514 extends upward from rolling cart base 510. A height adjustment collar 515 on pole 514 allows coarse height positioning of the arm assembly along the pole. An upper pole 516 extends from or within pole 514 above height adjustment collar 515, and a second height adjustment collar 517 on upper pole 516 provides a second stage of height adjustment.

Upper pole 516 is rotatable within or relative to pole 514, allowing the arm assembly to be swung laterally to reposition the worksurface platform in the horizontal plane without moving the cart base. Post clamp mount 410 secures the arm assembly to upper pole 516 at a selected height set by height adjustment collar 517.

The arm subassembly of assembly 500, including post clamp mount 410, telescoping segments 414 and 416, cam lock lever 415, camber adjustment 450, and worksurface platform parts 402A and 402B, is the same as assembly 400 and operates in the same manner. The description of those elements set forth with respect to FIGS. 4A, 4B, and 4C applies equally to assembly 500 and is not repeated here.

In some examples, height adjustment along pole 514 or upper pole 516 is provided by a pneumatic post mechanism in place of height adjustment collars 515 and 517, allowing the user to raise and lower the arm assembly along the pole with reduced manual effort through pneumatic assistance. In other examples, a lockable swivel joint is interposed between upper pole 516 and post clamp mount 410, providing a discrete, positionable pivot point that allows the arm assembly to be rotated to a selected horizontal orientation and locked in place independently of the rotation available through upper pole 516 within pole 514. The lockable swivel constrains rotation to a defined angular range and is fixed by a locking mechanism at the swivel joint.

Pole 514, in some examples, has an oval or non-circular cross-section. A non-circular pole cross-section resists rotation of post clamp mount 410 about the pole axis without requiring a separate rotational locking mechanism, since the non-circular geometry of the pole bore in post clamp mount 410 prevents angular displacement under load. This configuration simplifies the mount interface and eliminates the rotational component of the swivel described above where fixed angular orientation is the preferred configuration.

Height adjustment collars 515 and 517, in some examples, are spring-detent collars that provide indexed height positions at discrete intervals along the pole rather than infinitely adjustable friction-clamp positions. In this configuration, one or more spring-loaded detent pins in the collar engage corresponding holes or recesses spaced along the length of the pole at the indexed height positions. The collar is lifted against the spring force to disengage the detents, slid to the desired height, and released to re-engage at the nearest indexed position. Indexed height adjustment provides repeatable height settings and reduces the risk of inadvertent height change under load compared to friction-clamp collars.

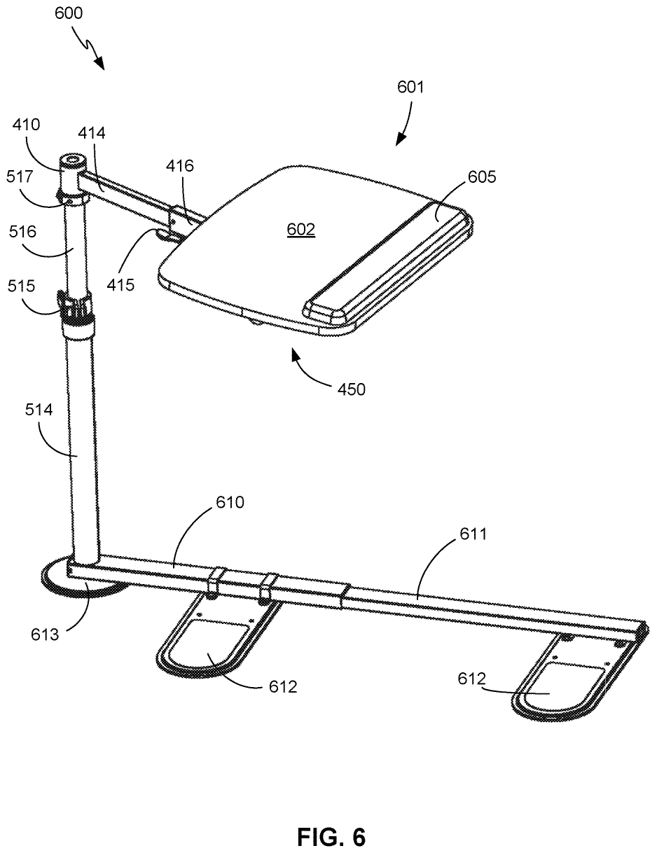

FIG. 6 illustrates a worksurface platform assembly 600 according to one example. Assembly 600 is a floor stand couch desk assembly that positions a worksurface platform adjacent to a seating surface such as a sofa or chair using a freestanding floor base rather than a wall bracket or rolling cart.

Assembly 600 includes a floor stand base 610 that rests on a floor surface and provides a stable, freestanding support structure. A plurality of feet 612 extend outward from floor stand base 610 to distribute the load and resist tipping. A pole foot 613 at the center of floor stand base 610 receives and supports a pole 514 extending upward from the base. A telescoping segment 611 within or extending from floor stand base 610 provides height adjustment of the pole relative to the base, allowing the overall assembly height to be set for different seating heights and user preferences.

Height adjustment collars 515 and 517 on pole 514 and upper pole 516, respectively, provide additional height adjustment stages as described with respect to assembly 500.

The arm subassembly of assembly 600, including post clamp mount 410, telescoping segments 414 and 416, cam lock lever 415, camber adjustment 450, and the worksurface platform, is the same as assembly 400 and operates in the same manner. Worksurface platform subassembly 601 includes worksurface platform 602 in place of the split platform of assembly 400; worksurface platform 602 is a keyboard tray configuration supported on a wrist pad 605. Post clamp mount 410 attaches to upper pole 516 at a height selected via height adjustment collar 517. The description of the arm, camber adjustment, and pole elements set forth with respect to FIGS. 4A, 4B, 4C, and 5 applies equally to assembly 600 and is not repeated here.

In some examples, a lockable swivel joint is interposed between upper pole 516 and post clamp mount 410 of assembly 600, as described with respect to assembly 500. The lockable swivel described in the context of assembly 500 is equally applicable to assembly 600 and operates in the same manner.

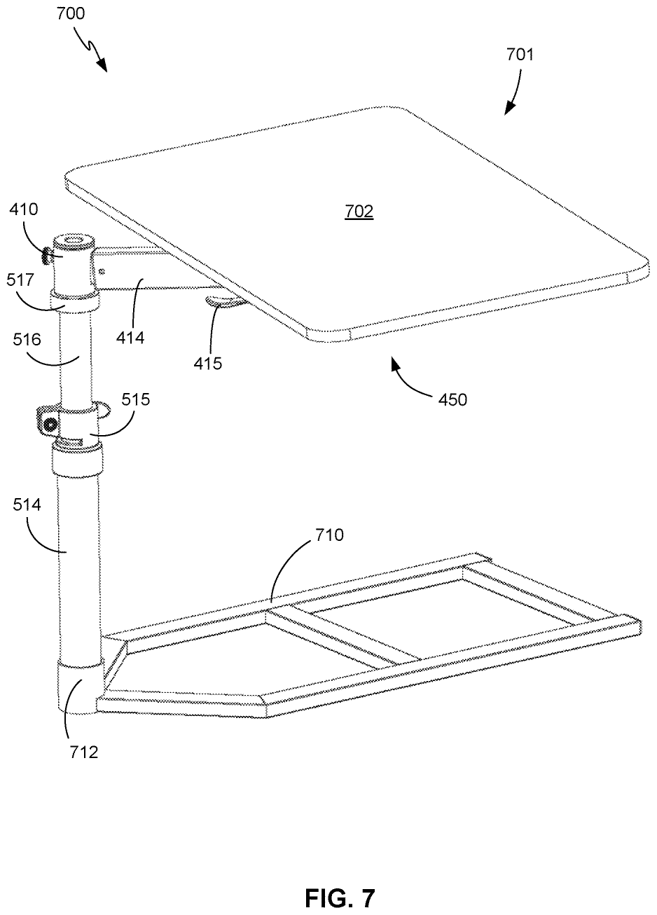

FIG. 7 illustrates a worksurface platform assembly 700 according to one example. Assembly 700 is an under-mattress desk assembly in which a pole and arm unit is anchored beneath a mattress, positioning a worksurface platform alongside the user while seated or reclining in bed.

Assembly 700 includes an under-mattress frame base 710 configured to be placed beneath a mattress and retained in position by the weight of the mattress above it. Under-mattress frame base 710 spans a width sufficient to provide a stable foundation against tipping and lateral movement during use. A post socket 712 extends upward from under-mattress frame base 710 and receives the lower end of pole 514, locating the pole at a fixed lateral position relative to the mattress edge. In some examples, under-mattress frame base 710 is available in multiple widths to accommodate twin, full, queen, and king mattress sizes, and may incorporate one or more retention straps, non-slip surface treatments, or cross-member configurations to resist lateral migration under the mattress during use.

Pole 514, upper pole 516, height adjustment collars 515 and 517, and post clamp mount 410 of assembly 700 correspond to the identically numbered elements of assemblies 500 and 600 and operate in the same manner. The arm subassembly of assembly 700, including post clamp mount 410, telescoping segments 414 and 416, cam lock lever 415, and camber adjustment 450, is the same as assembly 400 and operates in the same manner. Telescoping segment 416 is not shown in FIG. 7 as it is obscured by worksurface platform 702. Worksurface platform subassembly 701 includes worksurface platform 702, which is a tray surface supported at the distal end of the arm.

Clamp brackets 405, which provide the tilt adjustment allowing the user to set the forward/rearward angle of worksurface platform 702 relative to bar 403, are part of the platform mount structure of assembly 700 as described with respect to assembly 400; clamp brackets 405 are not shown in FIG. 7 for clarity of illustration of the assembly components. The tilt adjustment provided by clamp brackets 405 operates independently of and on an axis orthogonal to camber adjustment 450: the tilt adjustment sets the forward/rearward platform angle as an active ergonomic setting selected by the user, while camber adjustment 450 sets the side-to-side level of the platform as a static alignment adjustment. The description of the arm, camber adjustment, and pole elements set forth with respect to FIGS. 4A, 4B, 4C, 5, and 6 applies equally to assembly 700 and is not repeated here.

In some examples, under-mattress frame base 710 incorporates an integrated cable management tray running alongside pole 514 from the frame to the post socket 712. The cable management tray routes power and data cables along the pole in a concealed channel, reducing cable clutter at the bedside and protecting cables from compression under the mattress. The cable management tray may be formed integrally with under-mattress frame base 710 or attached as a separate channel clipped or fastened to the frame structure.

The examples described herein may be combined in various ways. The tilt joint 131 and tilt lever 133 of the 100-series assemblies may be incorporated into assembly 400 or any of the assemblies derived from it in place of the tilt adjustment provided by clamp brackets 405, providing a dedicated lever-operated forward/rearward tilt adjustment at the distal end of a telescoping arm. The dual-pin camber adjustment 450 of assembly 400 may be incorporated into the pneumatic wall-mounted assemblies 100, 200, and 300 in place of single-fastener camber adjustment 150, providing increased clamping redundancy for wall-mounted configurations subject to higher lateral loads.

In some examples, the camber adjustment is motorized: an actuator, for example, a small electric motor, a linear actuator, or a shape-memory alloy element, replaces the manual radially offset fastener as the element that drives and fixes the angular position of the first member relative to the second member about the pivot. A motorized camber adjustment allows side-to-side leveling to be performed without manual loosening and retightening of a fastener, and may be controlled via a button, dial, remote input, or application interface.

In some examples, a motorized camber adjustment incorporates position memory, storing one or more preset camber positions that the user can recall to return the worksurface platform to a previously set level without repeating the manual leveling procedure. Preset positions may be stored electronically or mechanically, for example, via indexed detent positions at the pivot interface, and recalled through a user input at the assembly or through a connected device.

In other examples, the mounting bracket or base of any of the described assemblies is a ceiling mount that suspends the worksurface platform arm downward from an overhead surface, positioning the worksurface platform above a bed, examination table, or reclining chair. A ceiling mount configuration inverts the arm orientation relative to the wall-mounted and floor-standing examples but retains the same arm, joint, and camber adjustment structure.

In some examples, tilt joint 131 and camber adjustment 150 are combined into a single integrated two-axis adjustment module interposed between the terminal segment of the arm and the worksurface platform. The integrated module provides both forward/rearward tilt adjustment, on a first axis, and side-to-side camber adjustment, on a second axis orthogonal to the first, within a single compact unit. Combining both adjustments into a single module reduces the number of discrete joints between the arm and the platform, simplifies the assembly interface, and allows the two adjustment axes to be set and fixed through a common clamping mechanism or through separate fasteners at the same joint location. This integrated two-axis adjustment unit is applicable to any of the arm configurations described herein.

In some examples, a visual angle indicator, such as a bubble level or an engraved angular scale, is incorporated adjacent to the oversize hole of the camber adjustment to facilitate leveling without external instruments. A bubble level positioned on the platform mount or on the face of the first member of the camber adjustment provides direct visual feedback of the side-to-side level condition as the user rotates the first member about the pivot. An engraved scale adjacent to the oversize hole allows the user to set and reproduce a specific camber angle numerically, which is useful in multi-unit installations where consistent platform angles are required across assemblies.

Any of the base configurations described herein, including mounting bracket 110, clamp mount 310, post clamp mount 410, rolling cart base 510, floor stand base 610, and under-mattress frame base 710, may be combined with a motorized height adjustment mechanism in place of the manual height adjustment provided by the locking gas spring of segment 120 or the height adjustment collars 515 and 517. A motorized height adjustment may use an electric motor, linear actuator, or pneumatic drive to raise and lower the worksurface platform arm along the base structure, and may be controlled through a button, dial, remote input, or application interface as described with respect to the motorized camber adjustment above.

Terms such as upper, lower, vertical, horizontal, side, lateral, forward, rearward, inner, outer, proximal, and distal are used herein for convenience and refer to directions or orientations relative to the described or illustrated configuration. These terms are illustrative only and should not be construed as limiting the scope of the claims to any particular spatial orientation.

The specific techniques described herein with respect to assembly 100, assembly 200, assembly 300, assembly 400, assembly 500, assembly 600, and assembly 700 are merely illustrative of the general inventive concepts included in this disclosure as defined by the following claims.

The examples described herein are illustrative of the present disclosure and are not intended as limitations on the scope thereof. Variations and modifications will be apparent to those skilled in the art. The present disclosure includes all such variations, modifications, and combinations of features from the examples described herein, whether or not explicitly illustrated. The scope of the disclosure is defined by the appended claims and is not limited to the specific examples described above.

What is claimed is:

1. A worksurface platform assembly comprising:
a worksurface platform;
a mounting bracket or base;
a worksurface platform arm connected between the worksurface platform and the mounting bracket or base, the worksurface platform arm comprising a plurality of segments connected by one or more joints; and
a camber adjustment comprising:
a pivot,
a first member coupled to the worksurface platform,
a second member coupled to a terminal segment of the worksurface platform arm, and
a radially offset fastener extending through an oversize hole in one of the first member or the second member and fixed to the other of the first member or the second member,
wherein the pivot couples the first member to the second member for rotation about the pivot, and
wherein the radially offset fastener controls a rotational resistance of the first member relative to the second member about the pivot.

2. The worksurface platform assembly of claim 1, wherein the oversize hole comprises an arcuate slot concentric with the pivot.

3. The worksurface platform assembly of claim 1, wherein the radially offset fastener extending through the oversize hole simultaneously limits a range of angular rotation of the first member relative to the second member by abutting edges of the oversize hole at the limits of the range, and controls the rotational resistance of the first member relative to the second member by a clamping force between the first member and the second member.

4. The worksurface platform assembly of claim 1, wherein the radially offset fastener is tightened to a friction-control setting at which the rotational resistance permits the first member to rotate relative to the second member about the pivot in response to a force applied to the worksurface platform without loosening the radially offset fastener.

5. The worksurface platform assembly of claim 1, wherein the radially offset fastener is tightened to a position-lock setting at which the rotational resistance fixes an angular position of the first member relative to the second member about the pivot.

6. The worksurface platform assembly of claim 1, wherein the camber adjustment comprises a first radially offset fastener extending through a first oversize hole and a second radially offset fastener extending through a second oversize hole, the first and second radially offset fasteners each fixed to the other of the first member or the second member.

7. The worksurface platform assembly of claim 1, wherein the camber adjustment provides a limited angular range of adjustment of the first member relative to the second member about the pivot.

8. The worksurface platform assembly of claim 1, further comprising a worksurface platform mount coupled between the worksurface platform and the first member of the camber adjustment.

9. The worksurface platform assembly of claim 1, wherein the worksurface platform is selected from the group consisting of a keyboard tray, a laptop tray, a desk, and a table.

10. The worksurface platform assembly of claim 1, wherein the one or more joints include one or more of a hinge joint, a tilt joint, a four-bar linkage with a locking gas spring, a telescoping joint with a cam lock lever, a friction pivot, and a lockable pivot.

11. The worksurface platform assembly of claim 1, wherein the mounting bracket or base comprises a pole and a height adjustment collar on the pole, the height adjustment collar configured to set a height of the worksurface platform arm along the pole.

12. The worksurface platform assembly of claim 11, wherein the height adjustment collar is a first height adjustment collar, the pole comprises a lower pole and an upper pole, the upper pole rotatable within the lower pole, and the mounting bracket or base further comprises a second height adjustment collar on the lower pole configured to set a height of the upper pole relative to the lower pole, and a post clamp mount securing the worksurface platform arm to the upper pole.

13. The worksurface platform assembly of claim 1, wherein the mounting bracket or base is selected from the group consisting of a wall mounting bracket, a clamp mount, a post clamp mount, a rolling cart base, a floor stand base with a telescoping segment and a plurality of feet, and an under-mattress frame.

14. A worksurface platform assembly comprising:
a worksurface platform;
a mounting bracket or base;
a worksurface platform arm connected between the worksurface platform and the mounting bracket or base, the worksurface platform arm comprising a plurality of segments connected by one or more joints; and
a camber adjustment comprising:
a pivot,
a first member coupled to the worksurface platform,
a second member coupled to a terminal segment of the worksurface platform arm, and
a radially offset fastener extending through an arcuate slot in one of the first member or the second member and fixed to the other of the first member or the second member,
wherein the pivot couples the first member to the second member for rotation about the pivot, and
wherein the radially offset fastener extending through the arcuate slot simultaneously limits a range of angular rotation of the first member relative to the second member by abutting an end of the arcuate slot at a limit of angular travel, and controls a rotational resistance of the first member relative to the second member by a clamping force between the first member and the second member.

15. A worksurface platform assembly comprising:
a worksurface platform;
a mounting bracket or base;
a worksurface platform arm connected between the worksurface platform and the mounting bracket or base, the worksurface platform arm comprising a plurality of segments connected by one or more joints; and
a camber adjustment comprising:
a pivot,
a first member coupled to the worksurface platform,
a second member coupled to a terminal segment of the worksurface platform arm, and
a pin extending through an oversize hole in one of the first member or the second member,
wherein the pivot couples the first member to the second member for rotation about the pivot and controls a rotational resistance of the first member relative to the second member about the pivot, and
wherein the pin limits a range of angular rotation of the first member relative to the second member.

16. The worksurface platform assembly of claim 15, wherein the camber adjustment further comprises a second pin extending through a second oversize hole in the one of the first member or the second member, the second pin limiting the range of angular rotation of the first member relative to the second member.

17. The worksurface platform assembly of claim 15, wherein the oversize hole comprises an arcuate slot concentric with the pivot.

18. The worksurface platform assembly of claim 15, wherein the pivot is tightened to a friction-control setting at which the rotational resistance permits the first member to rotate relative to the second member about the pivot in response to a force applied to the worksurface platform.

19. The worksurface platform assembly of claim 15, wherein the pivot is tightened to a position-lock setting at which the rotational resistance fixes an angular position of the first member relative to the second member about the pivot.

20. The worksurface platform assembly of claim 15, wherein a friction washer is interposed between the first member and the second member at the pivot.

21. The worksurface platform assembly of claim 15, wherein the camber adjustment provides a limited angular range of adjustment of the first member relative to the second member about the pivot.

22. The worksurface platform assembly of claim 15, further comprising a worksurface platform mount coupled between the worksurface platform and the first member of the camber adjustment.

23. The worksurface platform assembly of claim 15, wherein the worksurface platform is selected from the group consisting of a keyboard tray, a laptop tray, a desk, and a table.

24. The worksurface platform assembly of claim 15, wherein the one or more joints include one or more of a hinge joint, a tilt joint, a four-bar linkage with a locking gas spring, a telescoping joint with a cam lock lever, a friction pivot, and a lockable pivot.

25. The worksurface platform assembly of claim 15, wherein the mounting bracket or base comprises a pole and a height adjustment collar on the pole, the height adjustment collar configured to set a height of the worksurface platform arm along the pole.

26. The worksurface platform assembly of claim 25, wherein the height adjustment collar is a first height adjustment collar, the pole comprises a lower pole and an upper pole, the upper pole rotatable within the lower pole, and the mounting bracket or base further comprises a second height adjustment collar on the lower pole configured to set a height of the upper pole relative to the lower pole, and a post clamp mount securing the worksurface platform arm to the upper pole.

27. The worksurface platform assembly of claim 15, wherein the mounting bracket or base is selected from the group consisting of a wall mounting bracket, a clamp mount, a post clamp mount, a rolling cart base, a floor stand base with a telescoping segment and a plurality of feet, and an under-mattress frame.
